(19) United States
(12) Patent Application Publication
(10) Pub. No.: US 2010/0131921 A1
(43) Pub. Date: May 27, 2010

(54) EXPOSING ASYNCHRONOUS MECHANISMS AS FIRST-CLASS EVENTS

(75) Inventors: John Wesley Dyer, Monroe, WA (US); Henricus Johannes Maria Meijer, Mercer Island, WA (US); Danny Van Velzen, Redmond, WA (US); Jeffrey Van Gogh, Redmond, WA (US); Mark Brian Shields, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/277,907

(22) Filed: Nov. 25, 2008

(51) Int. Cl. G06F 9/44; G06F 9/45

(52) U.S. Cl. 717/107; 717/136

(57) ABSTRACT

Conversions can be applied to various asynchronous and/or concurrent mechanisms. In particular, such mechanism can be transformed into first-class events to facilitate processing with respect to first-class events including but not limited to querying. Both conventional events and asynchronous computations can be transformed to these events, for example by generating and linking a proxy event thereto.

### CROSS-REFERENCE TO RELATED APPLICATIONS

This application is related to U.S. patent application Ser. No. ______ [Atty. Ref.: MS325084.01/MSFTP2422US, Meijer, et al.], entitled UNIFIED EVENT PROGRAMMING AND QUERIES, filed Nov. 25, 2008, U.S. patent application Ser. No. ______ [Atty. Ref.: MS325083.01/MSFTP2423US, Meijer, et al.], entitled EXCEPTIONAL EVENTS, and U.S. patent application Ser. No. ______ [Atty. Ref.: MS325085.01/MSFTP2448US, Meijer, et al.], entitled LAZY AND STATELESS EVENTS, all of even date. The entireties of these applications are incorporated herein by reference.

### BACKGROUND

Event-based systems comprise a plurality of independent program parts or components that communicate by way of notifications. Events generally correspond to notable conditions that cause a change of state such as sensor output, user action, or component message. In other words, an event is a message that indicates that something has happened. Event-based programs and/or portion thereof begin, wait for events, perform some action, and continue until explicitly terminated. By contrast, batch programs begin, perform one or more actions, and stop.

Event-based programs are implemented with two main components: event triggers (a.k.a. sources or senders) and event handlers (a.k.a. sinks or receivers). Triggers emit a signal or notification upon detecting the occurrence of an event. One or more event handlers respond to this notification by performing an action specific to the event. For example, upon detection of a button click, an event, some functionality is performed related to the click. Stated differently, a sender can detect an event and transmit a notification to a listening receiver, which can perform some designated action.

Furthermore, events are tightly coupled to classes similar to the relationship between a class and a class property. For instance, consider the following exemplary code snippet:

Button b = new Button( );
b.Click += DoSomething( );

Here, a new button “b” of type “Button” is constructed. Subsequently, an event “Click” is specified with respect to button “b,” and an event handler “DoSomething( )” is added to this event. Accordingly, both the event and the handler are tied to the “Button” class.

Asynchronous programming is conventionally distinct from event-based programming. Synchronous programming calls for a single execution path. By contrast, asynchronous programming employs multiple execution paths and concurrent operation. More specifically, a caller on a first thread can invoke a callee on a second thread that executes some functionality and returns a result to the caller. Moreover, asynchronous operations do not wait or block for a response from before continuing execution as is done with synchronous operations. Rather, the caller continues operation and is able to accept the result from the callee at anytime. Consequently, asynchronous programming is often employed with respect to time intensive tasks such as connecting to a remote computer and querying a database, among other things.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to exposure of asynchronous mechanisms as first-class events. First-class events can be subject to concise, declarative, and compositional query processing. To enable this processing, among other things, conventional representations of asynchronous computation are transformed to first-class events. In accordance with one implementation, a proxy event can be generated and linked to a legacy event to produce a composite first-class event with particular properties. Further, existing forms of asynchronous operations can be transformed into a first-class event representation. Still further yet, blocking operations can be converted into non-blocking first-class events, and synchronous functions can be transformed into asynchronous functions.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a computation transformation system in accordance with an aspect of the claimed subject matter.

FIG. 2 is a block diagram of a representative first-class event component according to a disclosed aspect.

FIG. 3 is a block diagram of a representative first-class event component in accordance with an aspect of the disclosure.

FIG. 4a illustrates an exemplary interface diagram for a first-class event according to a disclosed aspect.

FIG. 4b depicts an exemplary interface diagram for a standard first-class event according to an aspect.

FIG. 5 is a block diagram of a conversion component in accordance with an aspect of the disclosure.

FIG. 6 is a block diagram of a blocking operation conversion system according to a disclosed aspect.

FIG. 7 is a block diagram of a synchronous function conversion system in accordance with an aspect of the disclosure.

FIG. 8 is a flow chart diagram of a method of exposing asynchronous computations as first-class events in accordance with a disclosed aspect.

FIG. 9 is a flow chart diagram of conversion method in accordance with an aspect of the disclosure.

FIG. 10 is a flow chart diagram of a block operation conversion method according to a disclosed aspect.

FIG. 11 is a flow chart diagram of a synchronous function conversion method in accordance with an aspect of the disclosure.

FIG. 12 is a schematic block diagram of an exemplary system within which aspects of the disclosure can be practiced.

FIG. 13 is a schematic block diagram illustrating a suitable operating environment for aspects of the subject disclosure.

FIG. 14 is a schematic block diagram of a sample-computing environment.

### DETAILED DESCRIPTION

Systems and methods pertaining to exposure of asynchronous and/or concurrent mechanisms as first-class events are described in detail hereinafter. There are a number of existing methods for dealing with asynchronous and/or concurrent computation. However, various kinds of push-based computation including asynchronous and/or concurrent computation, among others, can be unified under a common event-based framework. Moreover, query processing can be employed over first-class events to enable declarative, compositional, and concise programming. Accordingly, existing models or the like of asynchronous and/or concurrent computation can converted to first-class events to support the framework and query processing, among other things.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

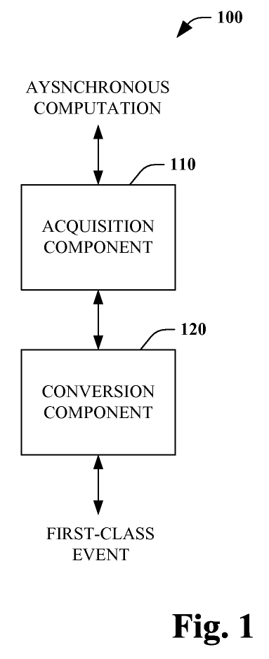

Referring initially to FIG. 1, a computation transformation system 100 is illustrated in accordance with an aspect of the claimed subject matter. The system 100 includes an acquisition component 110 and a conversion component 120 communicatively coupled. The acquisition component receives, retrieves or otherwise acquires or obtains asynchronous and/or concurrent computations. Such computations can include, without limitation, conventional or legacy events and asynchronous calls of various representations. For instance, asynchronicity can be represented conventionally by way of a BeginInvoke/EndInvoke mechanism, continuations/callbacks, virtual methods, or futures, among other design patterns. The conversion component 120 can receive or otherwise obtain computations from the acquisition component 110. The computations can then be converted to first-class events by the component 120, which can be subject to query or other processing.

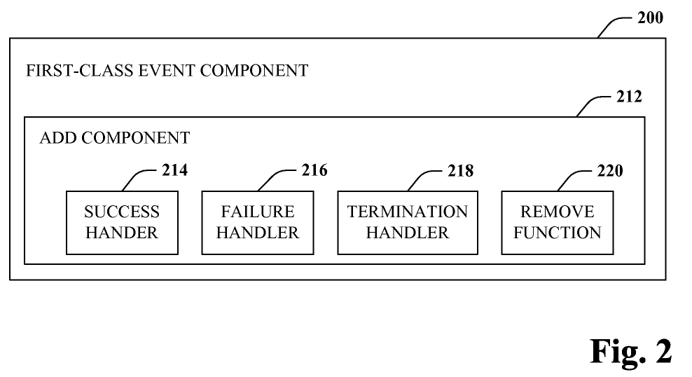

FIG. 2 depicts a representative first-class event component 200 in accordance with an aspect of the claimed subject matter. Conventionally, events are second-class citizens of a programming language that are tightly coupled to classes much in the same way as properties and the like. By contrast, first-class events behave much in the same way as other first-constructs such as integers and strings. Accordingly, the events can be stored and passed around, among other things.

In accordance with an aspect, the event component 220 can include an add component adding and removing handlers to the event component 220. The add component 212 can add multiple handlers or handler components (e.g., 1-N). In one particular embodiment, a success handler 214, a failure handler 216, and a termination handler 218 can be added. The success handler 214 provides a value and/or callback that is invoked upon successful event creation and processing. The failure handler 216 can be a value and/or callback that is called upon a failure or exception in event production and/or processing. Further, the termination handler 218 provides a value and/or callback or the like to signal that a listener or asynchronous computation should be terminated. In other words, the termination handler 218 can act as a termination request. As a result, programmers can dictate functionality with respect to success, failure and termination. Furthermore, the add component 212 can return a function 220 that can remove added handlers as opposed to providing a remove component itself, as will be described further infra.

It is to be appreciated that the first-class event component 200 can be lazy and stateless. In other words, addition of handlers can be deferred until a programmer specifies a handler. Subsequently, handlers can be propagated and composed from composite events to source events such that execution of the handler on the source is equivalent to execution of the handler on a composite event leaf. For example, the add component can pass handlers to an event higher in a chain.

Returning briefly to FIG. 1, it is to be noted that one or both components can form part of various other components or systems. For example, the components can form a portion of a code generator or rewriter. Additionally or alternatively, code can be injected into an application or employed to extend an existing library.

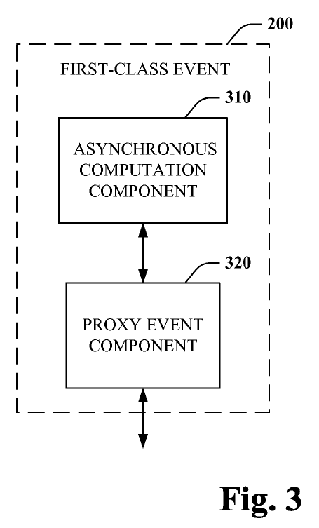

FIG. 3 depicts a representative first-class event 200 in accordance with an aspect of the claimed subject matter. The first-class event 200 comprises two components, namely asynchronous computation component 310 and proxy event component 320. The asynchronous computation component represents conventional asynchronous and/or concurrent computations and/or representations thereof (e.g., event, continuation/callback . . . ). The proxy event component 320 is linked to the asynchronous computation component 310 and affords a first-class event interface to the underlying asynchronous computation. In one instance, the proxy event component 320 can wrap the asynchronous computation component 310.

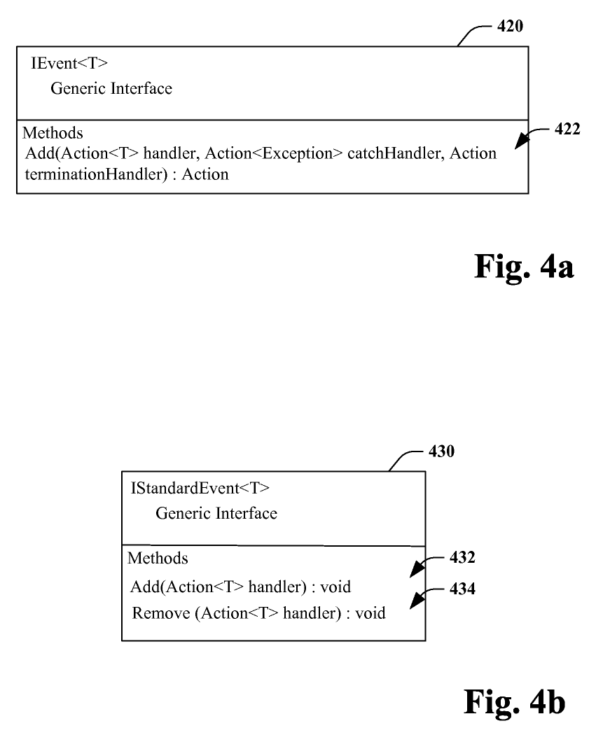

FIG. 4a illustrates an exemplary interface diagram 420 associated with a first-class event. Here, first-class events implement the “IEvent<T>” interface, where “T” is the type of the event. An event can also include an “Add” method 422, where the “Add” includes three handlers or categories of handlers for success, failure, and termination. Note also that the “Add” method returns an action or function able to remove an added handler.

While conventional events are not first-class, for purposes of further explanation, and not limitation, consider events (standard events) produced in accordance with the exemplary interface diagram 430 “IStandardEvent<T>,” where “T” is the type of the event, as shown in FIG. 4b. Events specified in accordance with the interface 430 can include two methods “Add” 432 and “Remove” 434. The “Add” method 432 enables addition of handlers to an event, and the “Remove” 434 removes identified handlers. Moreover, the interface 430 specifies a first-class event with minimum requirements for adding and removing handlers. Should one desire to produce first-class events in accordance with an aspect of this disclosure, the events would likely implement an interface such as standard event (IStandardEvent<T>).

There are three substantial differences between “IEvent<T>” 420 and “IStandardEvent<T>.” First, “IStandardEvent<T>” 430 includes add and remove functions, whereas the “IEvent<T>” includes only an add method, which returns the remove function. Second and third, the standard events do not deal with exceptions and termination. Conversions thus can ensure that these differences are captured.

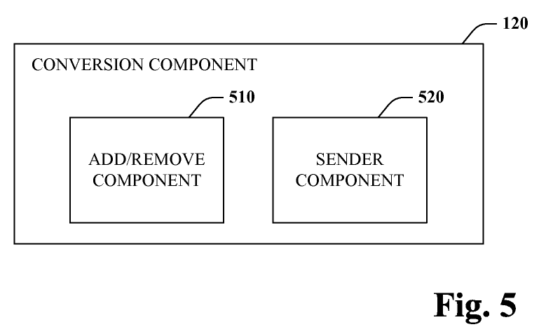

Turning attention to FIG. 5, an embodiment of the conversion component 120 is shown. In particular, the conversion component 120 can include add/remove component 510 and sender component 520. The add/remove component 510 enables conversion of add and remove functions into a single add function that returns remove function, for example. The sender component 520 enables elimination of a sender parameter, where present with respect to a legacy representation.

Conversion can be simplified into converting from dual add/remove to a single add function. A function “GetEvent” which takes an add and remove functions and returns a first-class event “IEvent<T> (which can employ a lazy event design philosophy and an anonymous inner-type design pattern), as follows:

```
public static IEvent<TValue> GetEvent<TValue>(
    Action<Action<TValue>> add, Action<Action<TValue>> remove)
{
    return new ProxyEvent<TValue>((succeeded, failed) =>
      {
        add(succeeded);
        return ( ) => remove(succeeded);
      });
}
```

Note that since lazy events are employed, no handlers are actually added in “GetEvent.” Instead, handlers are passed along to the add and remove parameters. In other words, the add and remove are parameterized.

However, some conventional events do not take handlers that have one parameter. For instance, a handler can take two parameters such as a sender and event arguments, where the sender identifies the source of an event and the arguments specify event data for use by the handler. Accordingly, conversion can defined as follows:

```
public static IEvent<TValue> GetEvent<TValue>(
  Action<EventHandler<TValue>> add,
  Action<EventHandler<TValue>> remove)
where TValue : EventArgs
{
    return new ProxyEvent<TValue>((succeeded, failed) =>
      {
        EventHandler<TValue> handler = (sender, eventArgs) =>
          succeeded(eventArgs);
        add(handler);
        return ( ) => remove(handler);
      });
}
```

Here, the sender parameter can safely be ignored, because inner delegates or representations thereof can capture the sender in the succeeded or failed method that is passed into the functions. However, if needed, conversions can be modified to include both the sender and event arguments by first defining a new type that combines both the sender (e.g., type object) and event arguments, and changing the return type and code in the body as appropriate.

Now conversion between standard events to first-class “IEvent<T>” events can involve forwarding standard event to the previously defined “GetEvent” helper function, which takes an add and remove function (passing the add and remove function of the standard event). For instance:

public static IEvent<T> GetEvent<T>(this IStandardEvent<T> e)
{
return GetEvent<T>(e.Add, e.Remove);
}

Now, when “GetEvent” is called, the result is a composite first-class event such as that shown in FIG. 3. When a handler is added to the composite first-class event, the handler is added to the standard event. For example, where add is specified as “pe.Add(x => f(x))” with respect to the proxy event, then “se.Add(x => f(x))” can be called with respect to the standard event. First-class events can return the remove handler when a handler is added, and in this case, the remove handler calls remove on the standard event with the added handler. For example: “( ) => se.Remove(x => f(x)).” The remove function remembers the handler that was added so that it can be removed.

It is to be noted that in many languages like C#, the add and remove functions cannot be directly referenced for various reasons. For example, if there exists a text changed event, which takes a handler “EventHandler<EventArgs>,” then none of the previously defined methods can be directly invoked. Consider for instance:
public event EventHandler<EventArgs> TextChanged;
   Nevertheless, delegates (e.g., types that reference methods that can be behave like the methods referenced) can still be defined which access the add and remove function. For example, consider the following code snippet.

var firstClassEvent = Event.GetEvent<EventArgs>(
handler => x.TextChanged += handler,
handler => x.TextChanged −= handler)

Here, “x.TextChanged += handler” and “x.TextChanged −= handler” are syntactic sugar for adding and removing a handler, respectively, that hides the add and remove function. However, these functions can be passed in utilizing lambda expressions, which are equivalent to exposing the underlying actions directly.

Extension methods can then be provided for each event, which exposes that event as a first-class event. For instance:

```
public static IEvent<EventArgs> GetTextChanged(this Control c)
{
  return Event.GetEvent<EventArgs>(
    h => c.TextChanged += h,
    h => c.TextChanged −= h);
}
```

Additionally, these extension methods can be organized such that by including some namespace, all of the conversions from the events in the namespace will be available.

Furthermore, a general conversion can be supplied that takes an object and a string representing an event member name and the employs reflection to create the corresponding first-class event, as follows:

public static IEvent<TValue> GetEvent<TValue>(this object target,
string eventName)

The function looks for a member, which is an event with a name “eventName” on “target.” It then checks to see if the handler takes one parameter of type “TValue” or two parameters of type object and “TValue,” where “TValue : EventArgs.” If either of these is the case then the delegate representing the handler is constructed and the corresponding “GetEvent” definition is invoked.

By way of example, consider the method “GetTextChanged,” where there is a “GetEvent” to perform “c.TextChanged.” Of course, there are also other events like “GetClicked” that have “c.Clicked + h.” For each event, the pattern is get “xxx,” where “xxx” is the event name and inside the method specifies “c.xxx += h” and “c.xxx −= h.” The above method uses reflection and parameterizes over an event name “xxx.” This is more convenient, but also more dangerous and slower because of the use of reflection. Accordingly, use thereof can be dependent upon circumstances, for instance where convenience concerns outweigh the danger and slower execution.

While events can be utilized to represent asynchronous operations, another common pattern is BeginInvoke/EndInvoke. To start an asynchronous operation, the BeginInvoke function is invoked. When the operation completes, the callback is called making an asynchronous result available. EndInvoke may be called inside the callback to extract the return value or exception.

The BeginInvoke/EndInvoke pattern can be converted to a first-class event by using a proxy event (e.g., lazy event). This will start the computation for each handler when the handler is added. Otherwise, the computation can be started immediately and results shared across multiple handlers. Below is a code snippet illustrating a representative conversion function/method with respect to the BeginInvoke/EndInvoke pattern:

```
public static Func<T, IEvent<U>> ToAsync<T, U>(
  Func<T, AsyncCallback, object, IAsyncResult> begin,
  Func<IAsyncResult, U> end)
{
  return t => new ProxyEvent<U>((succeeded, failed) =>
    {
      begin(t, asyncResult =>
        {
          var result = default(U);
          try
          {
            result = end(asyncResult);
          }
          catch (Exception ex)
          {
            failed(ex);
            return;
          }
          succeeded(result);
        }, null);
    });
}
```

Here, the “ToAsync” function/method converts the BeginInvoke/EndInvoke pattern to a first-class event. The return value is a function from “T” to “IEvent<U>.” One desires to call a function that given a “T” returns a “U,” but asynchronously. Accordingly, the function does not return immediately but rather asynchronously.

Asynchronous operations can be embodied by a plurality of other patterns including continuation-passing style (CPS). Converting from CPS interfaces is similar to the BeginInvoke/EndInvoke pattern except that the EndInvoke does not need to be called and instead work is directly done on the parameter in the callback. Here, the continuation can correspond to the handler. Accordingly, the handler can be made first class. Other asynchronous operations subject to analogous conversion to events include but are not limited to futures and virtual methods. For example, a function can be called and a future or promise is returned by that represents a thing that is evaluated, the asynchronous computation.

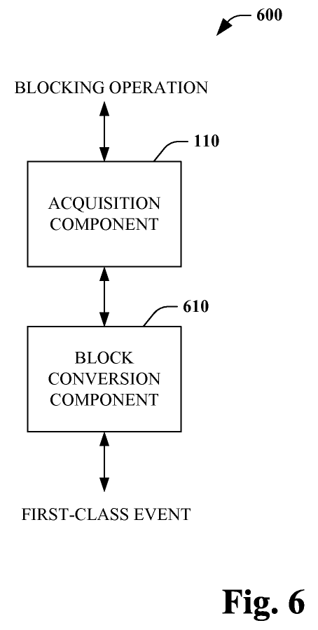

In accordance with an aspect of the disclosure, a number of other conversions are contemplated. FIG. 6 illustrates a blocking operation conversion system 600. Here, system 600 is simply a special version of system 100 of FIG. 1. Acquisition component 110 receives, retrieves, or otherwise obtains or acquires a blocking operation. Block conversion component 610 transforms a blocking operation into a non-blocking operation and more particularly a non-blocking first-class event, for instance. In one embodiment, this can be accomplished using the BeginInvoke/EndInvoke conversion or “ToAsync” function. The blocking operation is passed in a function and then BeginInvoke and EndInvoke members of the function can be used to make the operation non-blocking. Other concurrency mechanisms could be used here as well is a similar manner to BeginInvoke/EndInvoke conversion including but not limited to thread pools, futures and the like. The following provides a function/method signature of one exemplary embodiment:

public static IEvent<TResult> Start<TResult>(this Func<TResult>
function)
{
return ToAsync(function.BeginInvoke, function.EndInvoke)( );
}

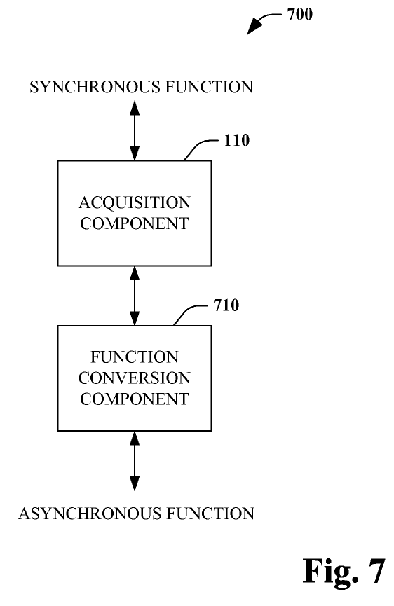

FIG. 7 illustrates a synchronous function conversion system 700 in accordance with an aspect of the claimed subject matter. Here, acquisition component 110 can receive, retrieve, or otherwise obtain or acquire a synchronous function or method. Function conversion component 710 can receive or retrieve a synchronous function and perform transformations/conversions on the synchronous function to produce an asynchronous function/method. In one embodiment, conversion from blocking to non-blocking can be employed to convert synchronous functions to asynchronous functions. For instance, consider the following:

public static Func<IEvent<TResult>> ToAsync<TResult>(this
Func<TResult> function)
{
return ( ) => Start(function);
}

Here, this function does not start immediately. Rather, it can be invoked at later time. Overall, any synchronous function can be passed thereto and an asynchronous version returned. Further, this can be done automatically thereby relieving programmers of the burden of specifying asynchronous function.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, such mechanisms can be employed with respect to automatic generation of first-class events and/or asynchronous functions. For instance, the conversion component 120 can infer first-class events from asynchronous computations.

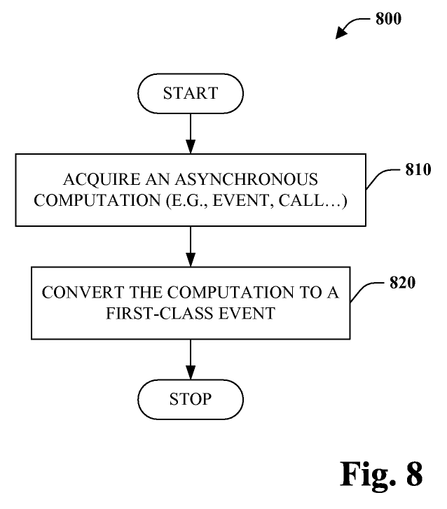

In view of the exemplary systems described supra, methodologies that may be implemented in accordance with the disclosed subject matter will be better appreciated with reference to the flow charts of FIGS. 8-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 8, a method 800 of exposing asynchronous computations as first-class events is illustrated. At reference numeral 810, an asynchronous computation is received, retrieved, acquired, or identified. Asynchronous computations can include without limitation conventional events and asynchronous calls (e.g., continuation/callback . . . ). At reference 820, an acquired asynchronous computation is converted to a first-class event potentially including various unique features (e.g., method for adding handlers for success, failure, termination and returning a remove function). Such conversion can involve transforming a computation into an event or generating a new event. In accordance with one aspect, a proxy event can produced and tied to a computation to produce a composite first-class event. Further, it is to be appreciated that at least one of acts 810 and 820 can be performed by automatic mechanism such as a code re-writer and/or code generator. Of course, actions can also be performed manually or semi-manually with the assistance of a tool, for instance.

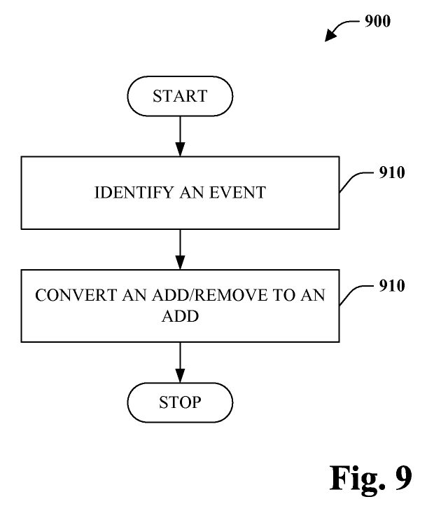

FIG. 9 is a flow chart diagram of a conversion method 900 in accordance with an aspect of the claimed subject matter. At numeral 910, an event is identified or acquired. The event can specify dual add and remove functions associated with adding and removing event handlers. In accordance with an aspect, it is desirable to employ a single add function for adding handlers such as but not limited to success and failure handlers that returns a remove function that when called removes added handlers. At 920, the dual add and remove functions can be converted into a single add that returns a remove function. In one implementation, a proxy event can be produced and tied to an event to produce a composite first-class event with a single add function/method.

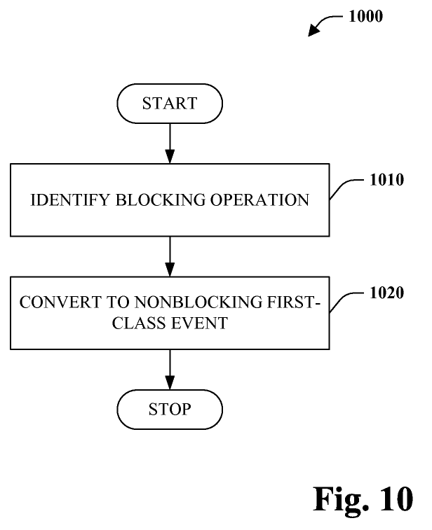

FIG. 10 is a flow chart diagram of a block operation conversion method 1000 in accordance with an aspect of the claimed subject matter. At reference numeral 1010, a blocking operation is identified, received, or retrieved. A blocking operation is associated with an operation that makes a call and blocks or waits until a response is provided prior to proceeding with computation. At numeral 1020, the blocking operation is converted to a non-blocking first-class event. In accordance with one implementation, the conversion can leverage conversion over asynchronous and/or concurrent patterns such as BeginInvoke/EndInvoke, futures, or the like. For example, a blocking operation can be passed in as a function and then BeginInvoke and EndInvoke members of the function used to make the operation non-blocking or convert it into a non-blocking first-class event.

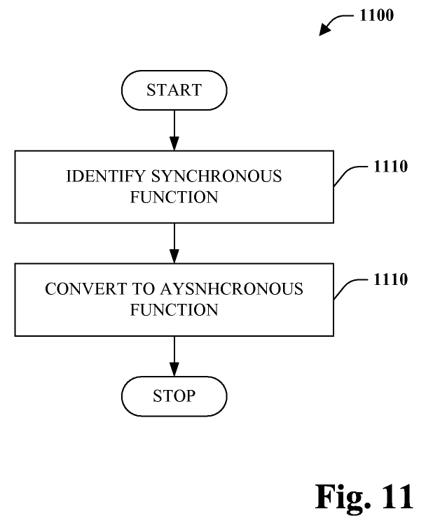

FIG. 11 is a flow chart diagram of a method of synchronous function conversion 1100 is depicted in accordance with an aspect of the claimed subject matter. At reference numeral 1110, a synchronous function, method or the like is identified or otherwise acquired. Where a synchronous function is included in a program, for example, the program waits for the function to complete execution prior to continuing execution. The identified synchronous function is then converted into an asynchronous function such that execution of the function in a program can allow the program to continue execute while the function executes. In accordance with one implementation, synchronous functions can be converted employing the conversion 1000 from blocking to non-blocking operations described above. More specifically, the method 1100 can simply involve calling method 1000 with the synchronous function and returning function that employs an event to callback to a caller.

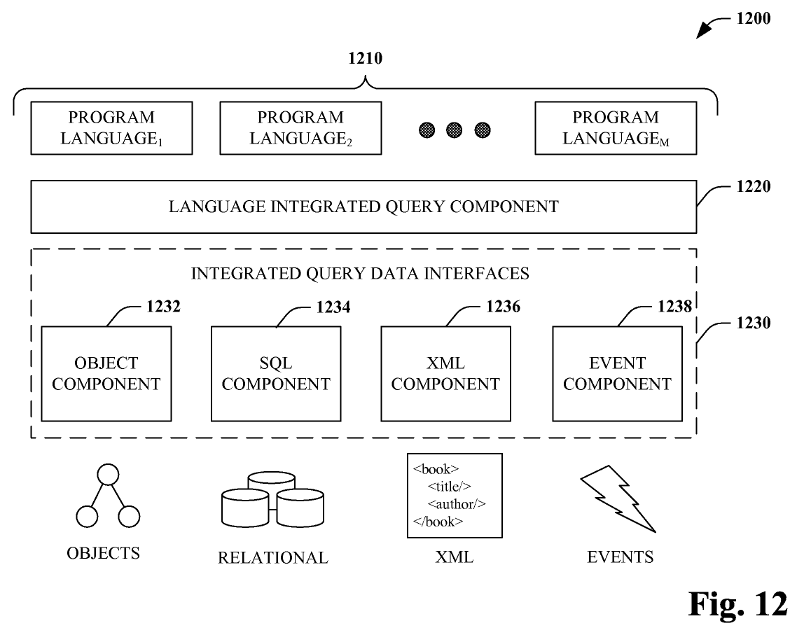

Turning attention to FIG. 12, an exemplary system 1200 is provided for which aspects of the claimed subject matter can be employed. In particular, the system 1200 can operate over a plurality of programming languages 1210 (PROGRAM LANGAUGE₁-PROGRAM LANGUAGE_{M}, where M is an integer greater than or equal to one). For example, such languages can include but are not limited object-oriented languages such as to C#, Visual Basic, and Java. Such multi-language operation can be supported by a framework including a library of pre-coded functionality and a virtual machine that manages execution of programs targeted therefor.

The system 1200 also includes a language integrated query component, facility or the like 1220. This component 1220 enables integration of declarative style queries, similar to those utilized with respect to SQL (Structured Query Language), to be integrated with a user's primary programming language 1210. Further, the component 1220 allows query expressions to benefit from compile-time syntax checking, static typing, and intelligent assistance, among other things previously only available to imperative code.

Additionally, the system 1200 includes a plurality of integrated query data interfaces 1230. These interfaces 1230 allow queries over different types of data. As shown, object component 1232 enables queries over objects; SQL component 1234 allows structured query language queries over relational data; and XML component 1236 enables interaction with extensible markup language (XML) data. Moreover, event component 1238 enables language-integrated queries over events. It is here where aspects of the claimed subject matter can be directed. By way of example and not limitation, various libraries of functions or features of the system 1200 can include legacy or other representations of asynchronous computations, that can be converted into first-class events to facilitate unified processing thereof, among other things.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

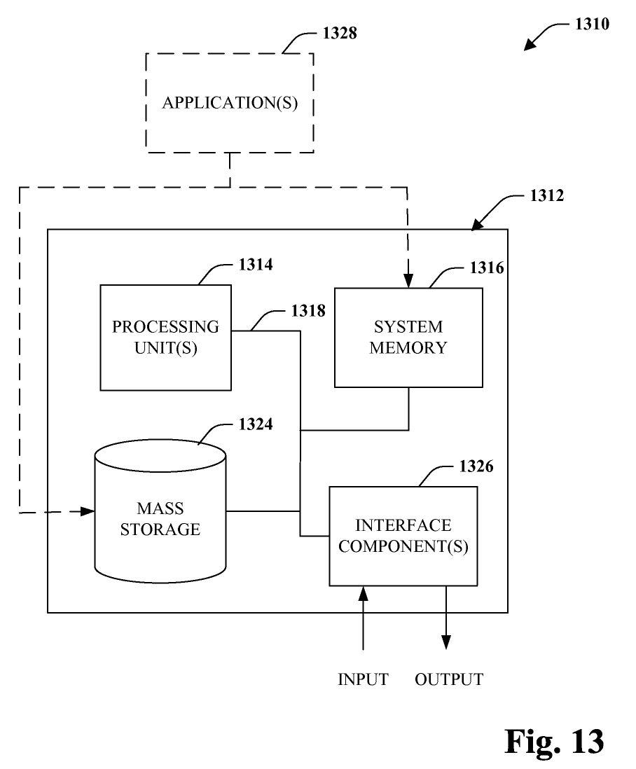

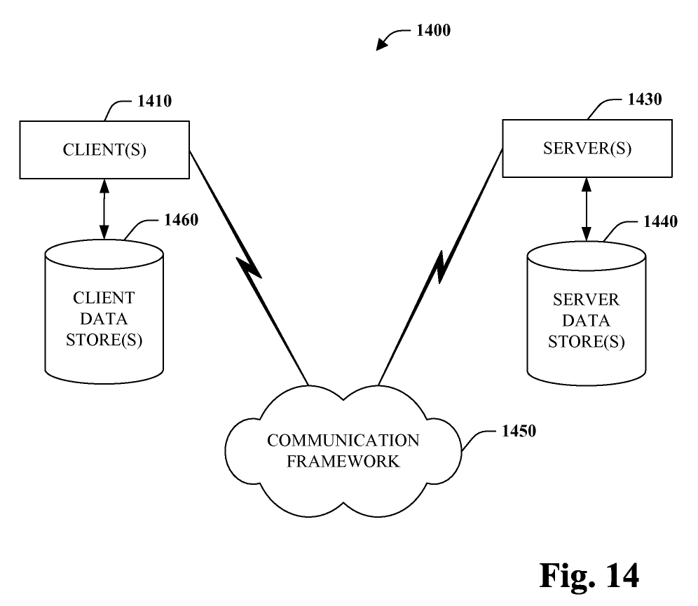

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 13, an exemplary environment 1310 for implementing various aspects disclosed herein includes a computer 1312 (e.g., desktop, laptop, server, hand held, programmable consumer or industrial electronics . . . ). The computer 1312 includes a processing unit 1314, a system memory 1316, and a system bus 1318. The system bus 1318 couples system components including, but not limited to, the system memory 1316 to the processing unit 1314. The processing unit 1314 can be any of various available microprocessors. It is to be appreciated that dual microprocessors, multi-core and other multiprocessor architectures can be employed as the processing unit 1314.

The system memory 1316 includes volatile and nonvolatile memory. The basic input/output system (BIOS), containing the basic routines to transfer information between elements within the computer 1312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1312 also includes removable/non-removable, volatile/non-volatile computer storage media. FIG. 13 illustrates, for example, mass storage 1324. Mass storage 1324 includes, but is not limited to, devices like a magnetic or optical disk drive, floppy disk drive, flash memory, or memory stick. In addition, mass storage 1324 can include storage media separately or in combination with other storage media.

FIG. 13 provides software application(s) 1328 that act as an intermediary between users and/or other computers and the basic computer resources described in suitable operating environment 1310. Such software application(s) 1328 include one or both of system and application software. System software can include an operating system, which can be stored on mass storage 1324, that acts to control and allocate resources of the computer system 1312. Application software takes advantage of the management of resources by system software through program modules and data stored on either or both of system memory 1316 and mass storage 1324.

The computer 1312 also includes one or more interface components 1326 that are communicatively coupled to the bus 1318 and facilitate interaction with the computer 1312. By way of example, the interface component 1326 can be a port (e.g., serial, parallel, PCMCIA, USB, FireWire . . . ) or an interface card (e.g., sound, video, network . . . ) or the like. The interface component 1326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the computer 1312 to output device(s) via interface component 1326. Output devices can include displays (e.g., CRT, LCD, plasma . . . ), speakers, printers, and other computers, among other things.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the aspects of the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1460 that can be employed to store information local to the client(s) 1410. Similarly, the server(s) 1430 are operatively connected to one or more server data store(s) 1440 that can be employed to store information local to the servers 1430.

Client/server interactions can be utilized with respect with respect to various aspects of the claimed subject matter. By way of example and not limitation, asynchronous computation can involve interaction between a client 1410 and a server 1430 across a communication framework 1450. Further, one or more components can form part of a web or network service. For instance, conversion of an asynchronous computation can be embodied as a web service employed by a client 1410.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A system that facilitates asynchronous processing, comprising:
a component that acquires an asynchronous computation; and
a conversion component that converts the computation into a first-class event.

2. The system of claim 1, the asynchronous computation is an event that adheres to a non-first-class design pattern.

3. The system of claim 1, the conversion component exposes a mechanism to facilitate termination of the asynchronous computation.

4. The system of claim 1, the conversion component employs one or more extension methods to convert the computation.

5. The system of claim 1, the conversion component employs reflection to convert the computation.

6. The system of claim 1, the asynchronous computation is implemented in accordance with a BeginInvoke/EndInvoke pattern.

7. The system of claim 1, the asynchronous computation is implemented according to a continuation passing style.

8. The system of claim 1, the conversion component generates and links a proxy event to the operation to produce the first-class event.

9. The system of claim 1, one or both of the components form part of a code rewriter or generation system.

10. The system of claim 1, where the first-class event enables adding handlers for success, failure, and termination.

11. A method of exposing operations as first-class events, comprising:
identifying an asynchronous or concurrent operation; and
transforming the operation into a first-class event by generating and linking a proxy event to the operation.

12. The method of claim 11, further comprising converting from add and remove functions to an add method that returns a remove function.

13. The method of claim 11, further comprising ignoring a sender parameter associated with the operation.

14. The method of claim 11, comprising transforming the operation with one or more extension methods.

15. The method of claim 11, comprising employing reflection to transform the operation.

16. The method of claim 11, comprising identifying an operation of a BeginInvoke/EndInvoke pattern.

17. The method of claim 11, comprising identifying an operation of a continuation passing style.

18. The method of claim 11, comprising identifying an operation of a virtual method or futures pattern.

19. A method of converting operations to first-class events, comprising:
identifying a blocking operation; and
converting the blocking operation into a non-blocking first-class event.

20. The method of claim 19, further comprising applying the conversion from blocking to non-blocking operation to convert a synchronous function to asynchronous function.
